(19) United States
(12) Patent Application Publication
(10) Pub. No.: US 2004/0162972 A1
(43) Pub. Date: Aug. 19, 2004

(54) Method for handling control transfer instruction couples in out-of-order, multi-issue, multi-stranded processor

(76) Inventors: Sorin Iacobovici, San Jose, CA (US); Rabin A. Sugumar, Sunnyvale, CA (US); Chandra M. R. Thimmannagari, Fremont, CA (US); Robert Nuckolls, Sunnyvale, CA (US); Suresh Thirumalaiswamy, Santa Clara, CA (US)

Correspondence Address: OSHA & MAY L.L.P./SUN, 1221 MCKINNEY, SUITE 2800, HOUSTON, TX, 77010, US

(21) Appl. No.: 10/368,745

(22) Filed: Feb. 18, 2003

(51) Int. Cl. G06F 9/00

(52) U.S. Cl. 712/239

(57) ABSTRACT

A method for handling a control transfer instruction couple includes fetching a plurality of instructions. The plurality of instructions include a control transfer instruction couple (or CTI couple), which includes a first branch instruction and a second branch instruction, leading instructions that precede the first branch instruction, trailing instructions that follow the second branch instruction, and buffered instructions that follow the trailing instructions. The method further includes decoding the CTI couple, forwarding the leading instructions and the first branch instruction for processing, freezing the trailing instructions and the delay slot to obtain frozen instructions, buffering the buffered instructions fetched after the freezing, and initiating an instruction refetch cycle dependent on a prediction of an execution of the first branch instruction.

### BACKGROUND OF INVENTION

A typical computer system includes at least a microprocessor and some form of memory. The microprocessor has, among other components, arithmetic, logic, and control circuitry that interpret and execute instructions necessary for the operation and use of the computer system. FIG. 1 shows a typical computer system (10) having a microprocessor (12), memory (14), integrated circuits (IC) (16) that have various functionalities, and communication paths (18, 20), i.e., buses and wires, that are necessary for the transfer of data among the aforementioned components of the computer system (10).

The instructions executed by the typical computer system shown in FIG. 1, at the lowest level, are a series of ones and zeroes that describe physical operations. Assembly code is an abstraction of the series of ones and zeroes representing physical operations within the computer that allow humans to write instructions for the computer. Examples of instructions written in assembly code include ADD, SUB, MUL, DIV, BR, etc. The examples of instructions previously mentioned are typically combined as an assembly program (or generally, a program) to accomplish sophisticated computer operations.

Instructions are executed sequentially; however, there are instructions that may change the flow of control in a program. Examples of instructions that may change control flow include jumps, branches, procedure calls, and procedure returns. A destination address of an instruction that changes the flow of control in a program must be specified. For example, for a branch instruction, which is a conditional change of flow control, the destination address must be determined before the instruction following the branch instruction can be executed.

Branch units use branch prediction methods to determine whether a branch instruction should be predicted as “branching” off to another instruction (predicted taken) or as falling through to the next instruction in the program (predicted untaken). The destination addresses are determined for branch instructions during execution. Branch instructions tend to affect microprocessor performance as the pipeline cannot be filled or the instructions in the pipeline need to be flushed to execute other sets of instructions. Therefore, branch prediction methods are used to efficiently manage branch instructions.

In one example of a branch prediction method, a branch history table (BHT) and a branch target cache (BTC) are used. The BHT stores entries, i.e., bits, to denote whether a branch instruction was previously taken or untaken. Based on previous instances in which a branch instruction was encountered, a prediction is made as to whether a current branch instruction should be taken or untaken. The BTC stores the destination addresses of several branches.

To ensure diligent execution of branch instructions, a delay slot is typically scheduled behind the branch instruction. The instruction in the delay slot, i.e., a delay slot instruction, is an instruction that does useful work during a change in control flow. For example, Code Sample 1 below shows a delay slot. The Code Sample1 includes a branch instruction (i.e., BR1), a delay slot instruction (i.e., ADD2), and a target instruction (i.e., SUB2).

### Code Sample 1: Delay Slot

| | Instruction | Description |
|---|---|---|
| 1 | ADD1 | Instruction 1 |
| 2 | SUB1 | Instruction 2 |
| 3 | BR1 | Branch Instruction 1 |
| 4 | ADD2 | Delay Slot of Branch Instruction 1 |
| 5 | . . . | |
| 6 | SUB2 | Target Instruction of Branch Instruction 1 |
| 7 | . . . | |

Branch instructions may have additional features that provide flexibility in scheduling the delay slot. For example, an annul bit “kills” (i.e., nullifies) the effect of the delay slot instruction in the event the branch instruction is predicted as not taken. If the annul bit is triggered, e.g., set to logic 1, and other nullifying conditions (i.e. circumstances in which the effect of the delay slot is nullified) of the branch instruction are satisfied, the delay slot instruction is killed. In Code Sample 1, if BR1 is predicted as not taken and annul bit is logic 1, then ADD2 in line 4 is killed i.e., the delay slot instruction will not be executed.

In certain cases, another branch instruction is in the delay slot. This is typically referred to as a control transfer instruction (CTI) couple. For example, Code Sample 2 shows a CTI couple. The Code Sample 2 includes a branch instructions (i.e., BR1), a subsequent branch instruction in the delay slot (i.e., BR2), and target instructions for the respective branch instructions (i.e., SUB1 and ADD1). The target instruction of the branch could be the instruction following the delay slot instruction if the branch instruction is predicted as not taken and could be the first instruction from the called sub-routine if the branch instruction is predicted as taken.

In line 1 of Code Sample 2, there is the first branch instruction, i.e., BR1, and the subsequent instruction is the delay slot instruction, which is also the second branch instruction, i.e., BR2. Not taking into account the annul bit, the second branch instruction (i.e., BR2) and the target instruction of the first branch instruction (i.e., BR1), which in this case, is the instruction following the delay slot of BR1, i.e., SUB1, will be executed if the first branch instruction is predicted as not taken. The delay slot of the second branch instruction, i.e., SUB1, and target instruction of the second branch instruction, which in this case, is the first instruction of the called sub-routine, i.e., ADD1, will be executed if the second branch instruction is predicted as taken. Finally, not taking into account the annul bit, if the first branch instruction is predicted as taken, then the target instruction of BRI, which in this case, would be the instruction from the sub-routine, i.e., ADD2 will be executed instead of SUB 1.

| | Instruction | Description |
|---|---|---|
| 1 | BR1 | Branch Instruction 1 |
| 2 | BR2 | Delay Slot of Branch Instruction 1 |
| 3 | SUB1 | Delay Slot of Branch Instruction 2 |
| 4 | . . . | |
| 5 | ADD1 | Target Instruction of Branch 2 |
| 6 | . . . | |
| 7 | ADD2 | Target Instruction of Branch 1 |

Continuing with Code Sample 2, in the event that the first branch instruction is predicted as not taken and the annul bit is set to logic 1 (in addition to other nullifying conditions being met), the second branch instruction is killed and potentially the wrong path of instructions is executed if the second branch instruction were to be predicted as taken and the prediction for the first branch instruction happened to be correct. Therefore, as shown in Code Sample 2, CTI couples potentially cause improper execution of instruction sets, if they are not properly handled.

### SUMMARY OF INVENTION

In general, one aspect of the invention relates to a method for handling a control transfer instruction couple. The method includes fetching a plurality of instructions. The plurality of instructions include a control transfer instruction couple, which includes a first branch instruction and a second branch instruction, leading instructions that precede the first branch instruction, trailing instructions that follow the second branch instruction, and buffered instructions that follow the trailing instructions.

The method further includes decoding the control transfer instruction couple, forwarding the leading instructions and the first branch instruction for processing, freezing the trailing instructions and the delay slot to obtain frozen instructions, buffering the buffered instructions fetched after the freezing, and initiating an instruction refetch cycle dependent on a prediction of an execution of the first branch instruction.

In general, one aspect of the invention relates to an apparatus for handling a control transfer instruction couple. The apparatus includes a fetch unit arranged to obtain a plurality of instructions. The plurality of instructions include a control transfer instruction couple, which includes a first branch instruction and a second branch instruction, leading instructions that precede the first branch instruction, trailing instructions that follow the second branch instruction, and buffered instructions that follow the trailing instructions.

The apparatus further includes a decode unit arranged to decode the control transfer instruction couple, forward the leading instructions and the first branch instruction for processing, and freeze the trailing instruction and the delay slot to obtain frozen instructions and responsive to initiation of an instruction refetch cycle.

Other aspects and advantages of the invention will be apparent from the following description and the appended claims.

### BRIEF DESCRIPTION OF DRAWINGS

FIG. 1 shows a block diagram of a typical computer system.

FIG. 2 shows a block diagram of a microprocessor in accordance with an embodiment of the present invention.

FIG. 3 shows a block diagram of a fetch unit with an instruction buffer in accordance with an embodiment of the present invention.

FIG. 4 shows a block diagram of an execution unit with a branch unit in accordance with an embodiment of the present invention.

FIG. 5 shows a block diagram of a commit unit with a live instruction table in accordance with an embodiment of the present invention.

FIG. 6 shows a pipeline diagram in accordance with an embodiment of the present invention.

FIG. 7A-7E show exemplary instruction formats of a branch instruction in accordance with an embodiment of the present invention.

FIG. 8 shows a flow diagram for processing a control transfer instruction couple in accordance with an embodiment of the present invention.

FIG. 9 shows a pipeline diagram of an execution of a control transfer instruction couple in accordance with an embodiment of the present invention.

### DETAILED DESCRIPTION

Like elements in various figures are denoted by like reference numerals throughout the figures for consistency.

In the following detailed description of the invention, numerous specific details are set forth in order to provide a more thorough understanding of the invention. However, it will be apparent to one of ordinary skill in the art that the invention may be practiced without these specific details.

Embodiments of the present invention relate to a method for handling control transfer instruction couples by decoding the control transfer instruction couple, forwarding instructions preceding a delay slot of the first branch instruction in the control transfer instruction couple, freezing instructions subsequent to the delay slot of the first branch instruction in the control transfer instruction couple including the delay slot, and initiating an instruction refetch (I-refetch) cycle. The method allows control transfer instruction couples to be properly executed in an out-of-order, multi-issue, multi-stranded microprocessor.

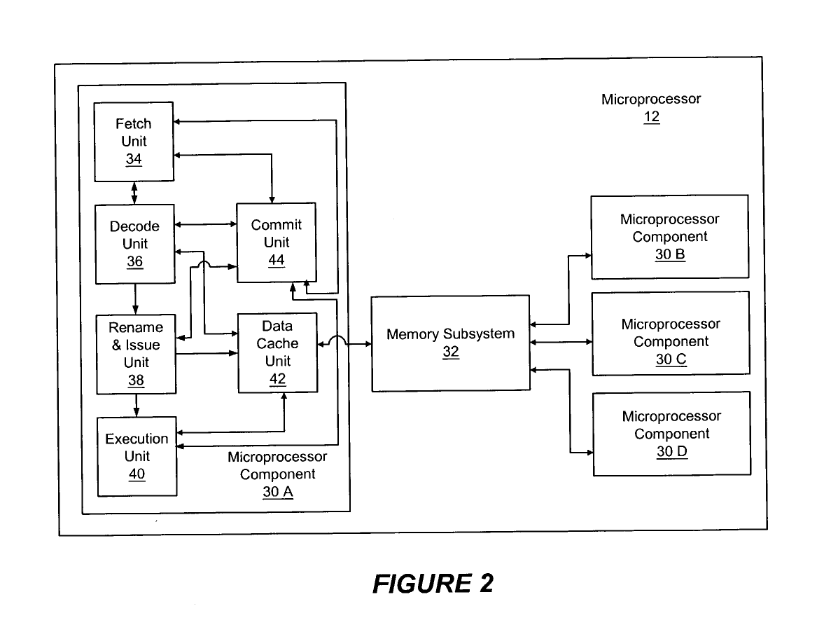

FIG. 2 shows an exemplary diagram of a microprocessor in accordance with an embodiment of the present invention. The microprocessor (12) includes four microprocessor components (30A-30D). The microprocessor (30A) is in communication with the microprocessor components (30B-30D) through a memory subsystem (32) that provides data for memory operations that missed in a cache memory (not shown) of the microprocessor components (30A-30 D). Each microprocessor component (30A-30D) includes a fetch unit (34), a decode unit (36), a rename and issue unit (38), an execution unit (40), a data cache unit (42), and a commit unit (44).

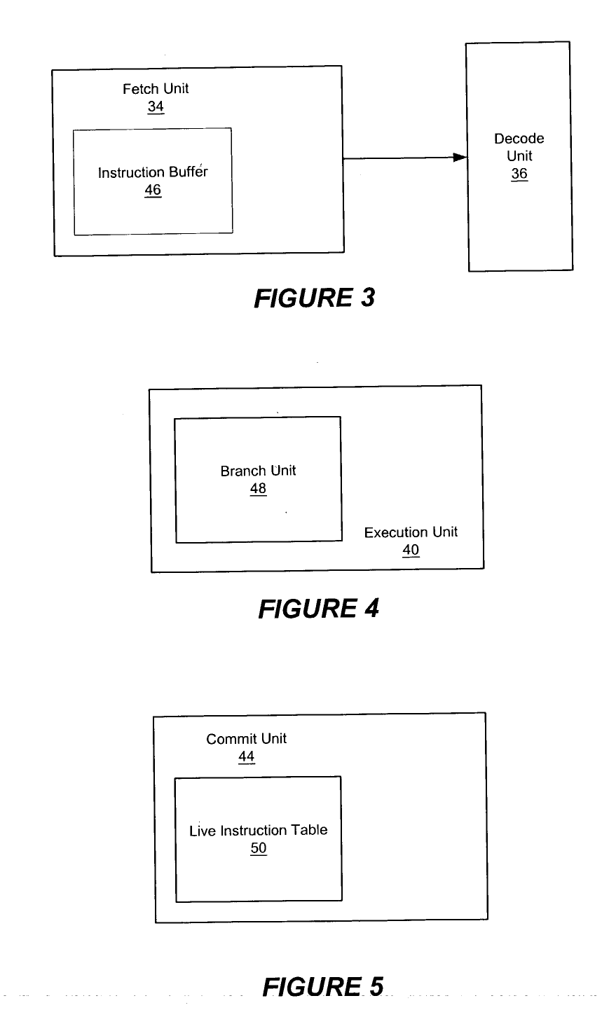

The fetch unit (34) typically fetches a set of instructions (i.e., a fetch group) in any given cycle from an instruction cache (not shown) and forwards the fetch group to the decode unit (36). An instruction buffer provides an interface between the fetch unit (34) and the decode unit (36). FIG. 3 shows a block diagram of a fetch unit (34) with an instruction buffer (46) in accordance with an embodiment of the present invention. The instruction buffer (46) in the fetch unit (34) has separate buffer logic dedicated to each strand. The instruction fetched for strand “zero” (i.e., the first strand) fetch in buffer logic dedicated for strand zero and instruction fetched for strand “one” fetch in buffer logic dedicated for strand one (i.e., the second strand). Based on a request from the decode unit (36), instruction buffer (46) will forward instructions from either buffer logic dedicated for strand zero or buffer logic dedicated for strand one. The fetch unit may also initiate a prediction signal with respect to branch instructions indicating whether the branch instruction is predicted as taken or untaken.

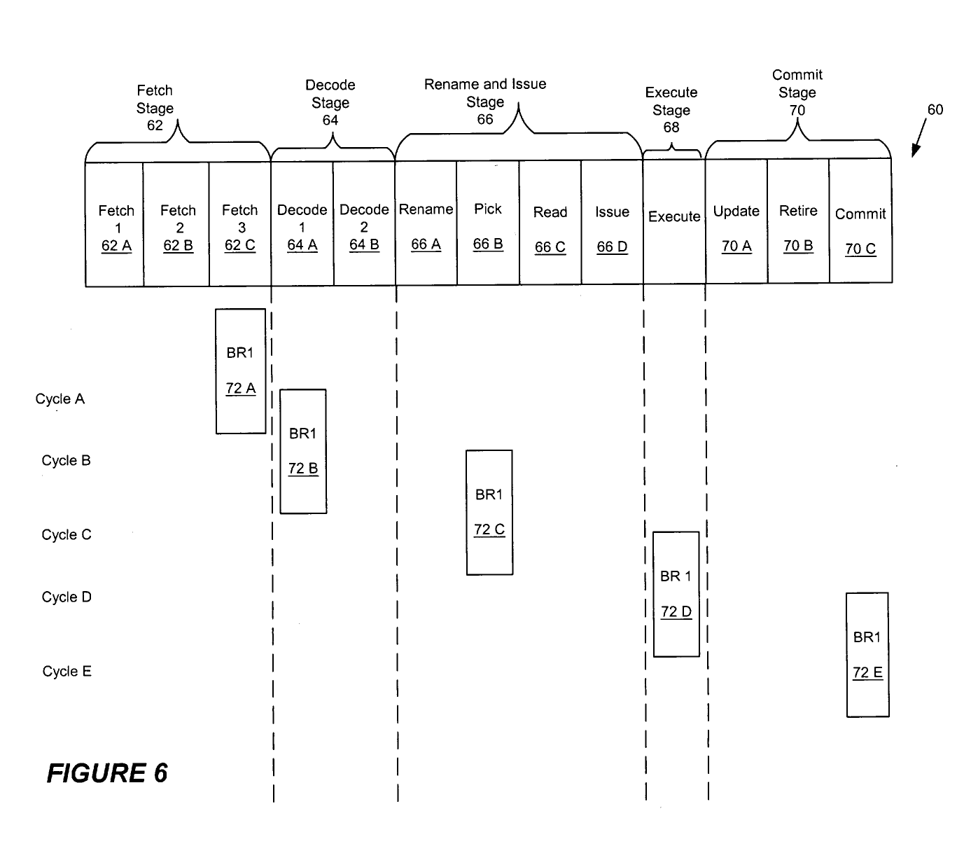

In FIG. 2, the decode unit (36) decodes the instructions forwarded by the fetch unit (34) and, in turn, forwards decoded instruction to the commit unit (44) and the rename and issue unit (38). Upon decoding the instruction or set of instructions, the decode unit (36) may also send a signal, e.g., freeze signal, to other functional units, e.g., commit unit (44), etc. The rename and issue unit (38) renames register fields along with updating appropriate rename tables. The issue queue (not shown) within the rename and issue unit (38) issues the instructions to the execution unit (40). The execution unit (40) executes the instructions and writes the results into a working register file (WRF) (not shown). In one or more other embodiments, the execution unit (40) may include a branch unit (48) as shown in FIG. 4.

FIG. 4 shows an execution unit (40) with a branch unit (48) in accordance with an embodiment of the present invention. The branch unit (48) verifies the predictive actions of the fetch unit (34 in FIG. 2 and 3) with respect to branch instructions, executes branch instructions, and/or calculates the refetch address of mispredicted branch instructions. A data cache unit (42 in FIG. 2) handles all of the loads and stores associated with executing the instruction.

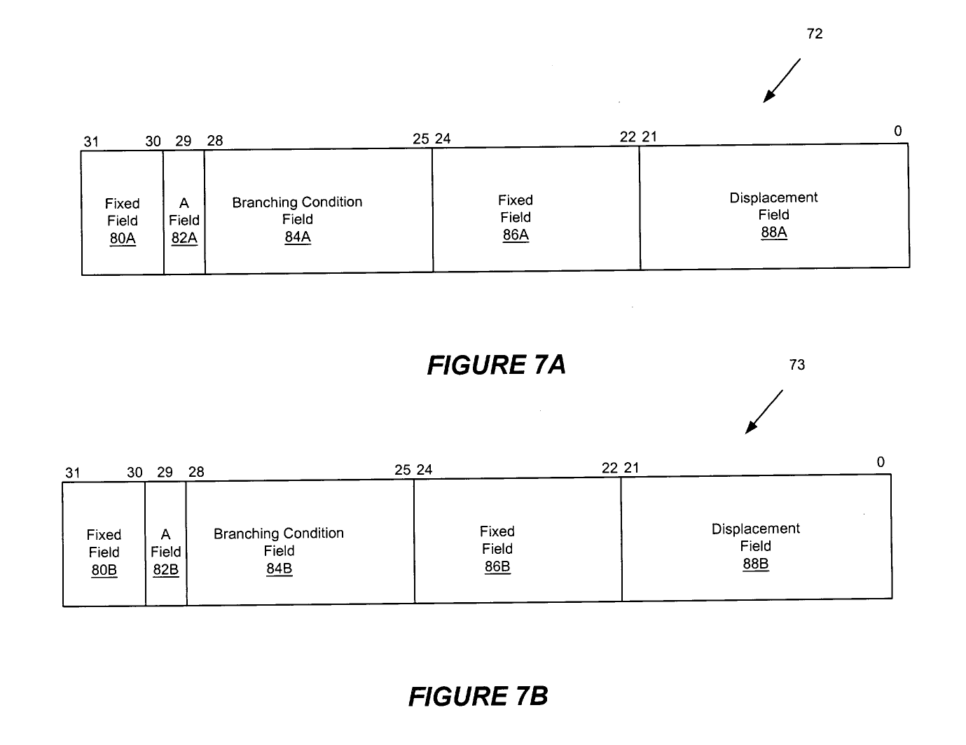

After an instruction finishes execution without exceptions, a commit unit (44 in FIGS. 2 and 5) commits the instruction, and in some cases writes the value in the WRF (not shown) to an architectural register file (ARF) (not shown). In one or more embodiments, the commit unit (44) may include a live instruction table (LIT). FIG. 5 shows a commit unit (44) with a live instruction table (50) in accordance with an embodiment of the present invention. The LIT (50) holds (i.e., to inventory) all active instructions in the pipeline. An instruction is considered active (live) from the time the instruction is decoded until it is committed. In one or more embodiments, the LIT (50) is a thirty-two entry structure in single strand mode is split betweens strands in multi-strand mode, i.e., each strand has access to sixteen entries. The LIT (50) catalogs information about the state of an instruction including physical and architectural register specifications, operational code (i.e., opcode) information, completion status, and trap status. If the LIT (50) for a particular strand is empty, the decode unit (36) may send a signal corresponding to that strand, e.g., an empty signal, to other functional units, e.g., the commit unit.

One skilled in the art will appreciate that a microprocessor may include more or less of the abovementioned functional units. Furthermore, the microprocessor may execute instructions in an out-of-order, multi-issue manner.

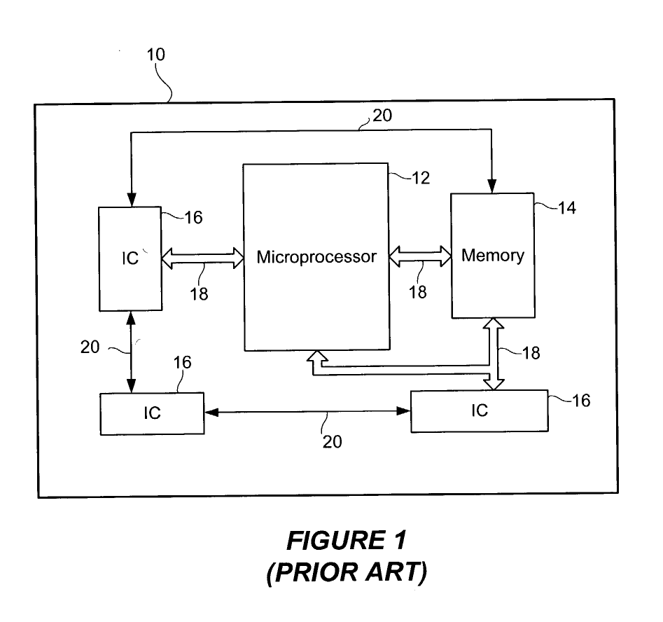

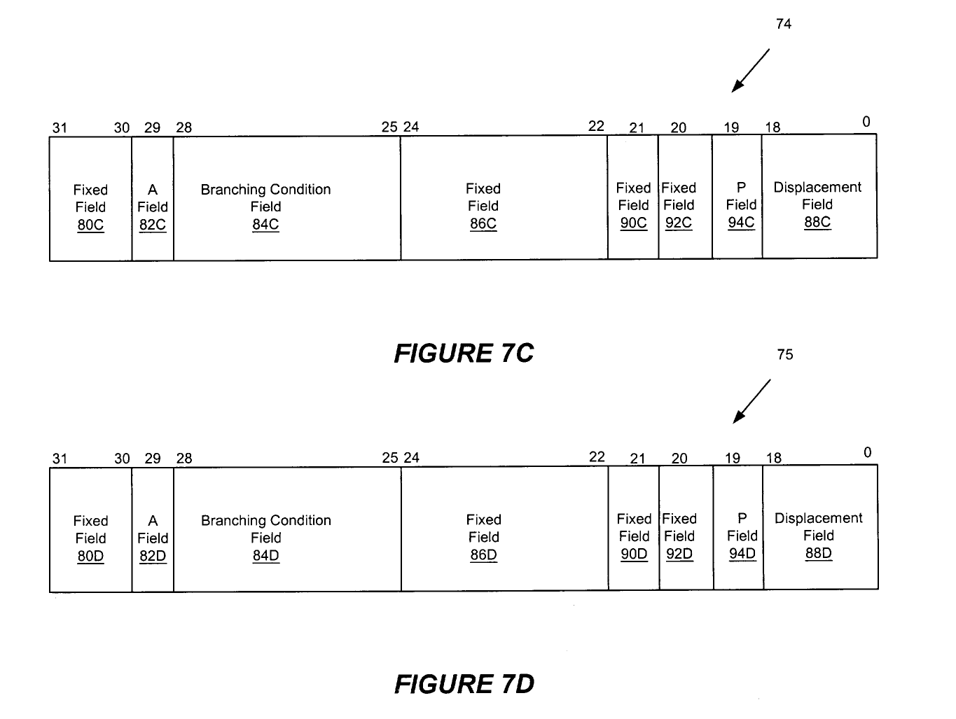

In one or more embodiments, the microprocessor (12) shown in FIG. 1 may have a pipeline arranged as shown in FIG. 6. FIG. 6 shows a diagram of a pipeline of an out-of-order, multi-issue microprocessor in accordance with an embodiment of the present invention. The pipeline (60) includes several stages, namely a fetch stage (62), a decode stage (64), a rename and issue stage (66), an execute stage (68), and a commit stage (70). In one or more embodiments, within each stage there are intermediary stages, e.g., the fetch stage (62) includes three intermediary fetch stages (62A-62C); the decode stage (64) includes two intermediary decode stages (64A, 64B); the rename and issue stage (66) includes four intermediary rename and issue stages (66A-66D); and the commit stage (70) includes three intermediary stages (70A-70C).

In one example, where a fetch group has only one instruction, which is valid and happens to be a branch instruction, the pipeline (60) shows how this branch instruction (72A-72E) progresses in cycles A through E. (Note that the cycles A through E are used to illustrate the propagation of a fetch group, i.e., in this case a single branch instruction, through the pipeline, accordingly, the cycles are not necessarily consecutive pipe stages.) In cycle A, the branch instruction (72 A) is currently in the third intermediary fetch stage (62C). Initially, in one or more embodiments, in the first intermediary fetch stage (62A), an instruction translation look-aside buffer (I-TLB), an instruction tag array, and branch prediction structures are accessed using the current fetch address. In the second intermediary fetch stage, the instruction data array is accessed using the current fetch address and a way select signal. In the last intermediary fetch stage (62C), instructions enter the instruction buffer (46) shown in FIG. 3. If the first fetched instructions belong to strand zero then they “wait” in buffer logic dedicated to strand zero, otherwise they “wait” in buffer logic dedicated to strand one.

In cycle B, the branch instruction (72B) enters the decode stage (64) at the first intermediary decode stage (64A). At this point, window spills, window fills, and complex instructions, etc. are detected. In the next intermediary decode stage (64B), among other tasks, the instructions are decoded for an execution unit, i.e., rename and issue unit, commit unit, etc.. In the following cycle, cycle C, the branch instruction (72C) is currently in the second intermediary rename and issue stage (66B), where priority arbitration of an instruction is resolved.

In cycle D, the actual “work” of the instruction is initiated, such that the branch instruction is executed. If the branch instruction is mispredicted in the execute stage (68), then the branch unit (48) shown in FIG. 4 initiates a reifetch signal.

In cycle E, the branch instruction (72E) is in the third intermediary commit stage (70C) where the instruction commits, and if the branch instruction (72E) is mispredicted, a signal, i.e., a clear pipe signal is initiated. In the first intermediary commit stage (70A), working register file may be updated with any values computed in the execute stage (68). Furthermore, in the last intermediary commit stage (70C), the architectural state changes as a result of the updated values in WRF. A clear pipe signal may be initiated once an instruction enters the last intermediary commit stage (70C) by the commit unit (44) upon receipt of both an empty signal and a freeze signal from decode unit.

Occasionally, instructions belonging to a strand in pipeline (60) need to be purged and a new set of instructions enter the fetch stage (62) and are processed in the decode stage (64). This action is known as an instruction re-fetch (I-refetch) cycle. In one or more embodiments, the I-refetch cycle occurs in two phases. A first phase of the I-refetch cycle involves clearing the instructions in the buffer logic (i.e., part of the instruction buffer), related to the strand on which the refetch was issued, and fetching a new stream of instructions for that strand to enter the fetch stage (62) as shown in FIG. 6 and clearing instructions related to the strand on which the reifetch was issued in the decode stage, i.e., the first and second intermediary stages (64A, 64B) shown in FIG. 6. It also involves initializing various counters related to that strand on which reifetch was issued in the decode unit. The first phase is initiated by a reifetch signal. A second phase of the I-refetch cycle involves clearing the freeze condition in the decode unit. The second phase is initiated by a clear pipe signal. As previously mentioned, the reifetch signal and the clear pipe signal may be initiated in different ways. In one instance, once a branch instruction is verified as a mispredicted branch instruction, the branch unit initiates a reifetch signal and the commit unit initiates a clear pipe signal. On the other hand, if the branch instruction is correctly predicted, the reifetch signal and clear pipe signal may also be initiated by the commit unit upon receipt of a freeze signal and an empty signal from the decode unit. The freeze signal indicates the identification of a CTI couple (as well as other states), where the empty signal indicates no “live” instructions are remaining in the LIT.

One skilled in the art will appreciate that the pipeline shown in FIG. 6 may include a different number of the pipeline stages in accordance with a particular design of a microprocessor.

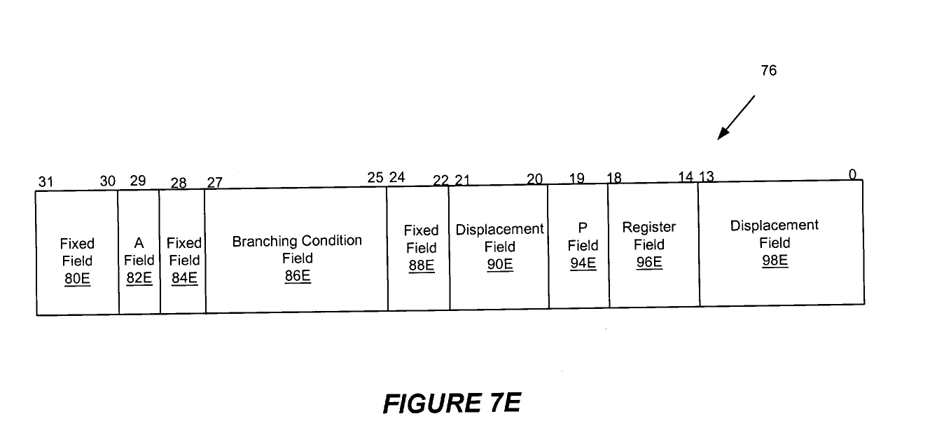

In one or more embodiments, the abovementioned branch instruction (72A-72E) that is propagated through the pipeline (60) has one of the five formats as shown in FIG. 7A-7E. FIG. 7A shows an embodiment of an instruction format of a branch instruction in accordance with an embodiment of the present invention. The branch instruction (72) is divided into five fields: two fixed fields (80A, 86A), an annul field (82A), a branching condition field (84A), and a displacement field (88A).

The branch instruction (72) is 32-bit field. The two fixed fields (80A, 86A) are two and three bit fields, respectively, and store fixed values. The annul field (82A) is a one bit field that nullifies the effect of the delay slot instruction if set to logic 1 in some cases. The branching condition field (84A) is a 4-bit field that encodes the condition under which the branch is taken.

In FIG. 7B, the branch instruction (73) format is similar to that of branch instruction (72) with respect to the fields, however the fixed field (86B) is encoded differently, i.e., fixed field (86A) associated with branch instruction (72) is encoded with “010,” whereas fixed field (86B) associated with branch instruction (73) is encoded with “110. ”

FIGS. 7C and 7D show an entirely different format. Branch instructions (74, 75) include eight fields: four fixed fields (80C, 86C, 90C, 92C or 80D, 86D, 90D, 92D), an annul field (82C or 82D), a branching condition field (84C or 84D), a displacement field (88C or 88D), and a prediction bit field (94C or 94D). The prediction bit field is a one bit field that is set by the assembler to indicate whether the instruction is predicted as taken or not taken. Branch instructions (74, 75) differ in that fixed fields (86C, 86D) use different encodings, i.e., fixed field (86C) associated with branch instruction (72) is encoded with “001,” whereas fixed field (86D) associated with branch instruction (73) is encoded with “101. ”

Another branch instruction format is shown in FIG. 7E. Branch instruction (76) include nine fields: three fixed fields (80E, 84E, 88E), an annul bit field (82E), a branching condition field (86E), two displacement fields (90E, 98E), a prediction bit field (94E), and a register field (96E). Branch instruction (76) is based on the contents of a register, i.e., this instruction “treats” contents of particular register as a signed integer value.

Table 1 provides examples of a variety of branch operations and the associated operational encodings. For example, the branch instruction requires a branch instruction to be taken, if the condition code register satisfies the not equal condition, then the encoding ‘1001’ is used in the branching condition field (84A).

TABLE 1
Examples of Branching Condition Encodings

| Operation | Encoding |
|---|---|
| branch if not equal | 1001 |
| branch if greater | 1010 |
| branch if greater or equal | 1011 |
| branch if equal | 0001 |
| branch if less | 0011 |
| branch if less or equal | 0010 |

To complete the encoding of the instruction, the displacement field (88A), a twenty-two-bit field, provides one of the address components for generating the address of the target instruction (i.e., the instruction to be executed if the branch instruction is executed as taken).

In addition to encoding the branching condition, the branch instruction (72-76) encodes the scheduling of the delay slot. For example, the annul bit (or field) being set to logic 1, as well as other nullifying conditions, i.e., logic ones and zeroes in the fixed fields and branching condition field, are required to kill the delay slot of a branch instruction.

TABLE 2
Nullifying Conditions of a Branch Instruction

| | | Branching | | | Branch Type |
|---|---|---|---|---|---|
| Fixed | Fixed | Condition | A | Prediction | (72, 73, 74, 75 |
| Field | Field | Field | Field | Signal | or 76) |
| 00 | 010 | 000 | 1 | X | 72 |
| 00 | 110 | 000 | 1 | X | 73 |
| 00 | 010 | !(000) | 1 | 0 | 72 |
| 00 | 110 | !(000) | 1 | 0 | 73 |
| 00 | 001 | 000 | 1 | X | 74 |
| 00 | 101 | 000 | 1 | X | 75 |
| 00 | 001 | !(000) | 1 | 0 | 74 |
| 00 | 101 | !(000) | 1 | 0 | 75 |
| 00 | 011 | X | 1 | 0 | 76 |

Please note in Table 1 “!” indicates “not” and “X” indicates “does not matter.”

Table 2 provides an exemplary set of conditions under which the delay slot of a branch instruction is killed, i.e., not executed. According to Table 2, if the bits of the branch instruction (72-76) contain any of the combinations as shown, the delay slot instruction is nullified. With respect to the branching condition field, the relevant bits are the twenty-fifth through the twenty-seventh bits. Additionally, in certain cases, the value of a prediction signal (last column of Table 2) may impact the nullification of a delay slot instruction. Particularly, if the prediction signal indicates a logic 0, the branch instruction is predicted as not taken.

One skilled in the art will appreciate that the nullifying conditions in Table 2 are exemplary. Therefore, there may be a variety of nullifying conditions of a delay slot instruction based on the implementation of the microprocessor.

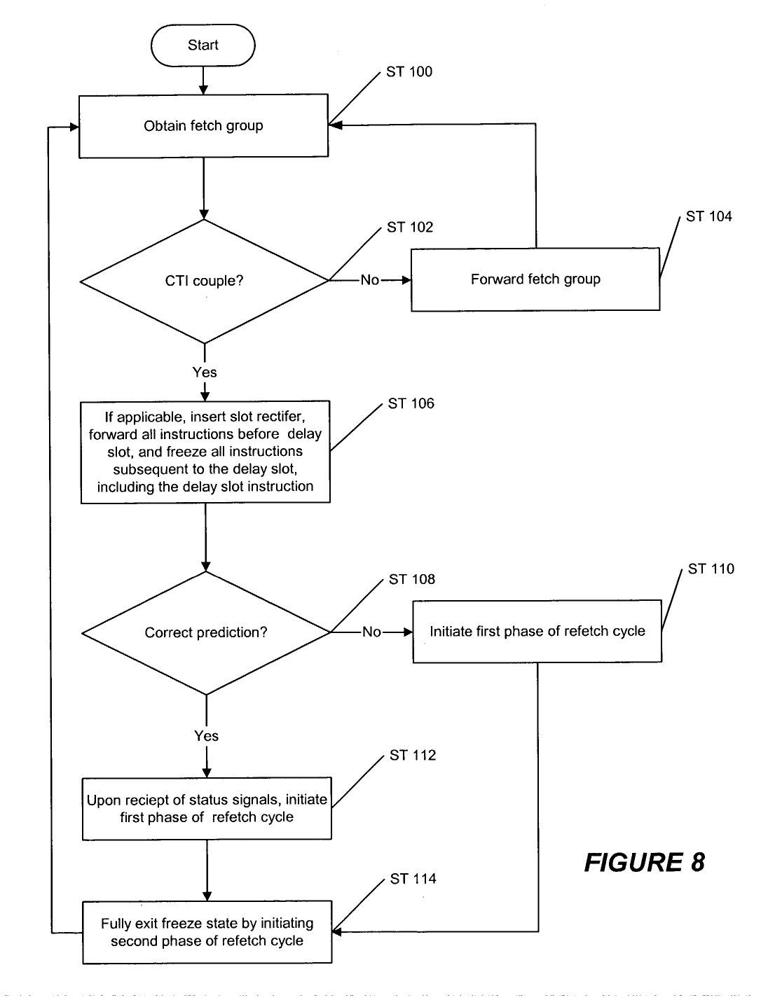

In the event that the abovementioned nullifying conditions are satisfied and the delay slot instruction is a branch instruction (i.e., CTI couple), the present invention properly processes the CTI couple. FIG. 8 shows a flow diagram of the processing of a control transfer instruction couple in accordance with an embodiment of the present invention.

Initially, a set of instructions (or fetch group) is obtained in a fetch unit (Step 100). The set of instructions are queued in an appropriate buffer logic in the instruction buffer (in the fetch stage) and are read by the decode unit. The decode unit identifies if a CTI couple is in the fetch group obtained in Step 100 (Step 102). If there is no CTI couple in the set of instructions, then the set of instructions are forwarded accordingly (Step 104). If a CTI couple exists, then a slot rectifier (or bubble) is inserted in current processing stage and in the next processing stage all instructions preceding the delay slot are forwarded to the execution unit and all instructions subsequent to the delay slot including the delay slot are frozen (i.e., stalled) in the decode stage of the pipeline (Step 106). If, however, a last instruction of a first fetch group is a branch instruction and the first instruction of a subsequent fetch group is a branch instruction, the first fetch group is forwarded and the second fetch group is frozen in the decode stage of the pipeline.

Freezing instructions or initiating a freeze state in the decode stage of the pipeline essentially blocks instructions from entering or exiting the decode stage of the pipeline. The decode stage exits the entering portion of freeze state when an I-refetch cycle is initiated by a reifetch signal and exits the exiting portion of the freeze state when an I-refecth cycle is initiated by a clear pipe signal. Once the entering portion of the freeze state is removed, newly fetched instructions are allowed into the decode stage of the pipeline. However, the newly fetched instructions are held and are not processed in the decode unit until a clear pipe signal is received by the decode unit.

The predictive actions initiated by the fetch unit regarding the first branch instruction are verified as correct or incorrect (Step 108). If the predictive actions were incorrect, i.e., a mispredicted branch instruction, then a first phase of an I-refetch cycle is initiated (Step 110) by the branch unit. Otherwise, upon receipt of status signals, namely a freeze signal and an empty signal, the first phase of the I-refetch cycle is initiated (Step 112) by the commit unit. After the initiation of the first phase of the I-refetch cycle, the second phase of the I-refetch cycle is initiated thereby fully exiting a freeze state (Step 114) by allowing newly fetched or to be fetched instructions in the decode stage to be processed.

Consequently, identifying the CTI couple and freezing the instructions subsequent to the delay slot including the delay slot (in Step 106) (i.e., the younger branch instruction forming the CTI couple) allows for verification of the first branch instruction before the second branch instruction is executed (or killed) providing proper execution of the CTI couple. Typically, if the first branch instruction is predicted as not taken and the second branch instruction is predicted as taken, and the first branch instruction met the nullified condition, then the second branch instruction is killed. If it is found that the first branch instruction is predicted correctly, the proper path of instructions would not be executed, if the second branch instruction was not frozen.

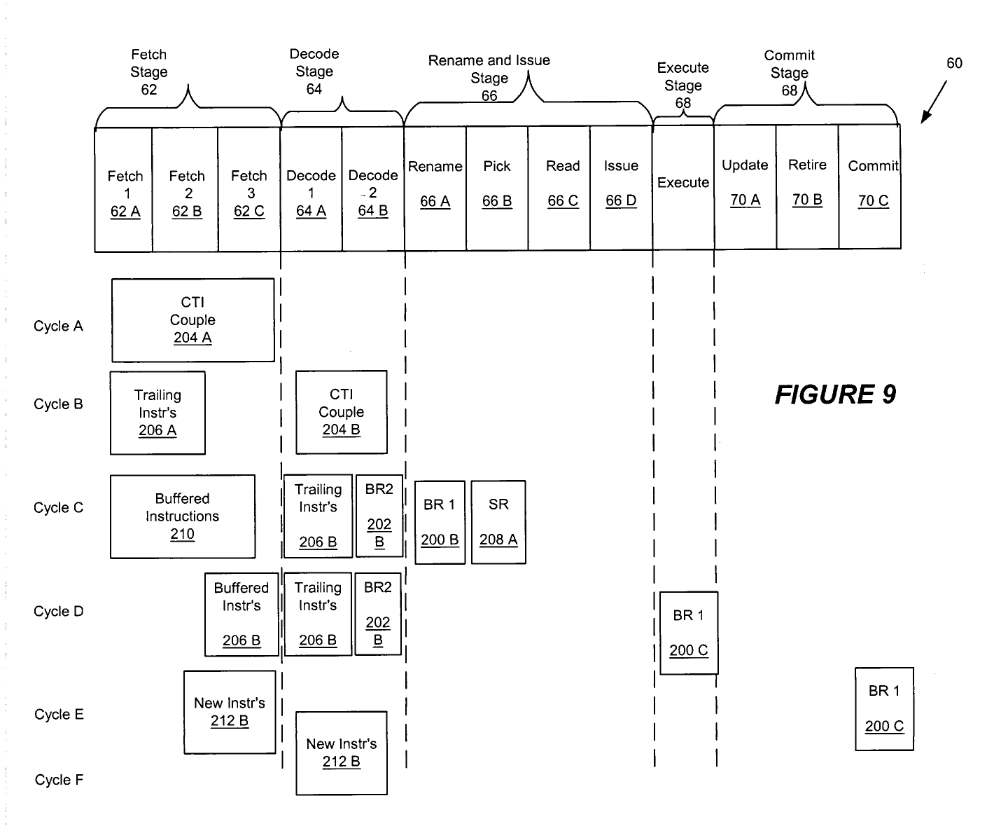

FIG. 9 shows a diagram of an execution of a fetch group with a CTI couple in a pipeline in accordance with an embodiment of the present invention. In cycle A, a fetch group with CTI couple (i.e., first and second branch instructions (200A, 202A) are in a fetch stage (62). At this point, some predictive action of the branch instructions (200A, 202A) is initiated, i.e., the branch instruction (200A, 202A) is predicted as taken or not taken.

During cycle B, the fetch group with the branch instructions (200A, 202A) reach a decode stage (64) and are identified as CTI couple (204). Because the CTI couple (204) is within the same fetch group, a slot rectifier (SR) (208A) (or bubble) is inserted (as shown in cycle C) i.e., in the stage prior to forwarding BRI, while stalling BR2 and the trailing instructions. The instructions subsequent to the CTI couple (204) are trailing instructions (206A). The trailing instructions (206 A) include target instructions for the respective branch instructions, as well as other associated instructions. After forwarding BRI, a freeze signal is sent to the commit unit by the decode unit indicating that a CTI couple has been identified.

In cycle C, the decode unit enters the freeze state and does not allow the second branch instruction (202B) and trailing instructions (206B) (i.e., instructions in the fetch group following the CTI couple) to exit, nor other instructions to enter. Therefore, the buffered instructions (210) remain in the instruction buffer.

In cycle D, the first branch instruction (200B) enters an execute stage (68). In the execution stage (68), the predictive actions of the first branch instruction (200B) of the CTI couple (204) is verified. In this case, the first branch instruction (200B) is mispredicted, therefore, a reifetch signal is initiated by the branch unit.

Consequently, in cycle E, the buffered instructions (210), the second branch instruction (202B), and the trailing instructions (206B) are purged and newly fetched instructions (212A) enter the fetch stage (62). Once the first branch instruction (200C) reaches the third intermediary commit stage (i.e., the commit stage) (70C), the clear pipe signal is initiated by the commit unit upon receipt of the freeze and empty signals from decode unit. Finally, in cycle F, the decode unit exits the freeze state, per the initiation of the clear pipe signal, and the new instructions (212B) are permitted to be processed in the decode stage (64) and upon processing prevents any blockage on these instructions from exiting beyond decode stage.

If the predictive actions of the first branch instruction (200A) were correctly predicted, then the refetch signal is not initiated until all valid instructions have been properly executed and committed. Subsequently, the clear pipe signal is initiated, thereby allowing the newly fetched instructions (212B) to be processed in the decode stage (64).

Advantages of one or more embodiments of the present invention may include one or more of the following. Reducing the fetch penalty on a CTI couple by allowing a branch unit and a commit unit to forward an early reifetch signal thereby forcing the fetch unit to fetch instructions and the decode unit to accept instructions. Also, results in simplifying branch related logic in fetch unit by allowing decode unit to handle delay slot killing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for handling a control transfer instruction couple, comprising:
fetching a plurality of instructions comprising:
a control transfer instruction couple comprising a first branch instruction and a second branch instruction;
leading instructions that precede the first branch instruction;
trailing instructions that follow the second branch instruction; and
buffered instructions that follow the trailing instructions;
decoding the control transfer instruction couple;
forwarding the leading instructions and the first branch instruction for processing;
freezing the trailing instructions and the delay slot to obtain frozen instructions;
buffering the buffered instructions fetched after the freezing; and
initiating an instruction refetch cycle dependent on a prediction of an execution of the first branch instruction.

2. The method of claim 1, wherein the initiating the instruction refetch cycle comprises a first phase and a second phase.

3. The method of claim 2, wherein the first phase comprises:
purging the buffered instructions and the frozen instructions; and
fetching new instructions.

4. The method of claim 2, wherein the second phase comprises exiting the freeze state.

5. The method of claim 1, wherein the first branch instruction is in a different fetch group than the delay slot.

6. The method of claim 1, further comprising:
inserting a slot rectifier if the control transfer couple is in a fetch group.

7. The method of claim 1, wherein the first branch instruction is in a same fetch group as the delay slot.

8. An apparatus for handling a control transfer instruction couple, comprising:
a fetch unit arranged to obtain a plurality of instructions comprising:
a control transfer instruction couple comprising a first branch instruction and a second branch instruction;
leading instructions that precede the first branch instruction;
trailing instructions that follow the second branch instruction; and
buffered instructions that follow the trailing instructions; and
a decode unit arranged to decode the control transfer instruction couple, forward the leading instructions and the first branch instruction for processing, and freeze the trailing instruction and the delay slot to obtain frozen instructions and responsive to initiation of an instruction refetch cycle.

9. The apparatus of claim 8, wherein the fetch unit comprises an instruction buffer arranged to buffer buffered instructions obtained by the fetch unit until prediction of an execution of the first branch instruction is verified.

10. The apparatus of claim 9, wherein the fetch unit is arranged to purge the buffered instructions in the instruction buffer and decode unit is arranged to purge the frozen instructions after the processing of the leading and the first branch instruction.

11. The apparatus of claim 8, further comprising:
a branch unit arranged to verify the prediction of the execution of the first branch instruction, wherein the branch unit initiates a first phase of an instruction refetch cycle.

12. The apparatus of claim 11, wherein the first phase of the instruction refetch cycle initiates a reifetch signal based on whether the first branch instruction is predicted incorrectly, and wherein purging of buffered and frozen instructions and fetching of new instructions is based on the reifetch signal.

13. The apparatus of claim 8, further comprising:
a commit unit arranged to finalize execution of the leading instructions and the execution of the first branch instruction, wherein the commit unit comprises a live instruction table arranged to inventory the leading instructions and the first branch instruction upon being forwarded by the decode unit until committed by the commit unit, and wherein the commit unit initiates a second phase of the instruction refetch cycle.

14. The apparatus of claim 13, wherein the second phase of the instruction refetch cycle initiates a clear pipe signal in response to a set of status signals, and wherein clearing the freeze state in the decode unit by allowing the decode unit to process newly fetch instructions is based on the clear pipe signal.

15. The apparatus of claim 14, wherein the set of status signals comprises an empty signal and a freeze signal, wherein the empty signal is initiated in response to the finalizing of the execution of the leading instructions and the first branch instruction, and wherein the freeze signal is initiated in response to the freezing of the trailing instructions and the delay slot.

16. The apparatus of claim 8, further comprising a slot rectifier, wherein the slot rectifier is arranged to be inserted prior to the fetch group that has the control transfer instruction couple.
